(19) United States
(12) Patent Application Publication
(10) Pub. No.: US 2003/0019828 A1
(43) Pub. Date: Jan. 30, 2003

(54) Hoist apparatus using a counter weight technology

(76) Inventors: Yong Wook Choi, Sungnam-City (KR); Hyun Gu Han, Suwon-City (KR)

Correspondence Address: Stephen A. Bent, Foley & Lardner, Washington Harbour, Suite 500, 3000 K. Street, N.W., Washington, DC, 20007-5143, US

(21) Appl. No.: 10/032,611

(22) Filed: Jan. 2, 2002

(30) Foreign Application Priority Data
Jul. 30, 2001 (KR) 2001-0046034

(51) Int. Cl. B66C 13/06

(52) U.S. Cl. 212/274

(57) ABSTRACT

A hoisting apparatus using a counterweight includes a drum (34) which turns when driven by electric power and is installed at a predetermined height in a predetermined structure, a first wire rope (40) having one end fixed to the drum, winding up around the drum when the drum turns in a first direction and unwinding from the drum when the drum turns in a second direction that is opposite to the first direction, a second wire rope (41) having one end fixed to the drum, winding up around the drum when the drum turns in the second direction, unwinding from the drum when the drum turns in the first direction, and having a predetermined hook device (37) for hooking and unhooking an object to be hoisted, installed at the other end of the second wire rope, and a counterweight (35) connected to the other end of the first wire rope.

### TECHNICAL FIELD

The present invention relates to a hoisting apparatus, and more particularly, to a high-performance hoisting apparatus using a counterweight.

### BACKGROUND ART

In general, hoisting apparatuses are used as cranes and elevators for lifting heavy objects by using electric power and moving the object up/down, left/right, and, forward/backward.

FIG. 1 illustrates a conventional hoisting apparatus in a crane for lifting heavy objects. As shown in FIG. 1, the conventional hoisting apparatus includes a drive unit 11 such as an electric motor, a drum 13 which turns in directions A, a wire rope 14 fixed to the drum 13 by means of one or a plurality of fixing members 12, and, a hook device 16 which is coupled to the object 15 to be lifted.

However, the hoisting apparatus used in the conventional crane is powered only by the drive unit 11. Thus, the heavier the object to be lifted is, the more power is needed for the drive unit, or a gear reducer with a greater reducing ratio should be used. It is a weak point that electric power consumption is high because weight lifting is done only by the electric motor.

FIG. 2 illustrates a conventional elevator as an example of the conventional hoisting apparatus. The conventional elevator shown in FIG. 2 includes a drive unit 24, sheaves 21 turning in directions B, an elevator car 23, counterweight 22, and a plurality of wire ropes connected to both the counterweight 22 and the elevator car 23.

In FIG. 2, the conventional elevator uses the drive unit 24 for moving the elevator car 23 by controlling the electric power of the drive unit 24 in order to control the rotation of the sheaves 21. However if the conventional elevator used only one wire rope, there would be a greater chance of slippage between the wire rope and the sheaves 21 and if a difference in weight between the elevator car 23 and the counterweight 22 gets bigger, it will not move up/down freely and the elevator car 23 may even fall down. Therefore, as shown in FIG. 2, when the weight-difference between the elevator car 23 and the counterweight 22 is big, the wire ropes 20 should be used to increase friction with the sheaves 21 that rotate by the power of the drive unit 24.

As described above, the conventional elevators use a number of wire ropes, which is a weak point because it complicates maintenance of the elevator. Also, due to uncertainty of the friction force between the wire ropes and the sheaves, when the elevator moves at a high speed or stops suddenly, slippage occurs between the wire ropes and the sheaves.

### DISCLOSURE OF THE INVENTION

In order to solve the above problems of conventional hoisting apparatuses, it is the first objective of the present invention to provide a hoisting apparatus using a counterweight which can hoist up a heavy object using a counterweight with the least number of wire ropes by means of a smaller drive unit so that, by using the drive unit, a heavier object can be lifted.

It is the second objective of the present invention to provide a wire rope towed trolley type crane using a counterweight which can hoist up a heavy object using a counterweight with the least number of wire ropes by means of a smaller drive unit so that, by using the drive unit, a heavier object can be lifted.

It is the third objective of the present invention to provide a machinery trolley type crane using a counterweight which can hoist up a heavy object using a counterweight with the least number of wire ropes by means of a smaller drive unit so that, by using the drive unit, a heavier object can be lifted.

It is the fourth objective of the present invention to provide a jib crane using a counterweight which can hoist up a heavy object using a counterweight with the least number of wire ropes by means of a smaller drive unit so that, by using the drive unit, a heavier object can be lifted.

Accordingly, to achieve the first objective of the present invention, there is provided a hoisting apparatus using a counterweight comprising a drum which turns when driven by electric power and is installed at a predetermined height in a predetermined structure, a first wire rope having one end fixed to the drum, winding up around the drum when the drum turns in a first direction and unwinding from the drum when the drum turns in a second direction that is opposite to the first direction, a second wire rope having one end fixed to the drum, winding up around the drum when the drum turns in the second direction, unwinding from the drum when the drum turns in the first direction, and having a predetermined hook device for hooking and unhooking an object to be hoisted, installed at the other end of the second wire rope, and a counterweight connected to the other end of the first wire rope.

It is preferred in the present invention that the object is an elevator car for carrying persons or cargo and the hook device provided at the other end of the second wire rope is connected to the elevator car.

It is preferred in the present invention that a drum for counterweight is connected to an additional rotation shaft installed at the drum and the first wire rope is fixed to the counterweight drum, so that when the counterweight drum turns in the first direction, the first wire rope winds up around the counterweight drum and, when the counterweight drum turns in the second direction, the first wire rope unwinds from the counterweight drum.

It is preferred in the present invention that a third wire rope is further provided, has one end fixed to the drum and winds up around the drum when the drum turns in the first direction, the other end of the first wire rope is drawn in a third direction that is a horizontal direction and is connected to the counterweight through a first sheave, and the other end of the third wire rope is drawn in a fourth direction that is the opposite direction to the third direction and is connected to another counterweight through a second sheave, so that a load in the horizontal direction is not applied to the drum with the help of the first and third wire ropes.

It is preferred in the present invention that a third wire rope is further provided, has one end fixed to the drum and winds up around the drum when the drum turns in the first direction, the other end of the first wire rope is drawn vertically and then drawn in a third direction that is a horizontal direction by a first sheave and is connected to the counterweight through a second sheave, and the other end of the third wire rope is drawn vertically and then in a fourth direction that is the opposite direction to the third direction by a third sheave and is connected to another counterweight through a fourth sheave.

To achieve the second objective of the present invention, there is provided a wire rope towed type crane using a counterweight comprising a trolley installed at a predetermined structure to be capable of moving horizontally, a hook having a hook device for hooking and unhooking an object to be hoisted and connected to the trolley to be capable of moving up and down by a plurality of sheaves and first and second wire ropes, first and second drums installed at a predetermined height to be rotated by a drive unit, wherein one end of each of the first and second wire ropes is fixed to the first drum and the other ends thereof are fixed to the second drum, so that, when the first and second drums turn in a first direction, the first and second wire ropes wind up around the first and second drums, respectively, and when the first and second drums turn in a second direction that is the opposite direction to the first direction, the first and second wire ropes unwind from the first and second drums, respectively, a third wire rope having one end thereof fixed to the first drum and winding up around the first drum when the first drum turns in the second direction and unwinding from the first drum when the first drum turns in the first direction, a fourth wire rope having one end thereof fixed to the second drum and winding up around the second drum when the second drum turns in the second direction and unwinding from the second drum when the second drum turns in the first direction, a first counterweight connected to the other end of the third wire rope, and a second counterweight connected to the other end of the fourth wire rope.

It is preferred in the present invention that the third wire rope drawn from the first drum is extended to the first counterweight by using a first wire rope extension with a plurality of sheaves, and the fourth wire rope drawn from the second drum is extended to the second counterweight by using a second wire rope extension with a plurality of sheaves, so that the hook can be moved up/down a greater distance than the first and second counterweights.

To achieve the third objective of the present invention, there is provided a machinery trolley type crane using a counterweight comprising a trolley installed in a predetermined structure to be capable of moving horizontally and having a drive unit, a rotating drum, and at least one wire rope having one end connected to the drum and the other end fixed to a fixed portion, a hook having a hook device for hooking and unhooking an object to be hoisted and connected to the trolley so that the hook can move up and down by the wire rope, wherein the wire rope winds up around the drum when the drum turns in a first direction and unwinds from the drum when the drum turns in a second direction that is the opposite direction to the first direction, a first wire rope having one end fixed to the drum and winding up around the drum when the drum turns in the second direction and unwinding from the drum when the drum turns in the first direction, a second wire rope having one end fixed to the drum and winding up around the drum when the drum turns in the second direction and unwinding from the drum when the drum turns in the first direction, and a counterweight connected to the other end of the first wire rope, wherein the other end of the first wire rope is drawn in a third direction that is a horizontal direction and is connected to the counterweight through a plurality of sheaves, and the other end of the second wire rope is drawn in a fourth direction that is the opposite direction to the third direction and is connected to the counterweight through a plurality of sheaves.

It is preferred in the present invention that the first wire rope drawn from the drum is extended to the counterweight by using a wire rope extension with a plurality of sheaves, and the second wire rope drawn from the drum is extended to the counterweight by using another wire rope extension with a plurality of sheaves, so that the hook can be moved up/down a greater distance than the counterweight.

To achieve the fourth objective of the present invention, there is provided a jib crane using a counterweight comprising a jib having a hook device for hooking and unhooking an object to be hoisted, and a body structure having a drive unit, a rotating drum, and a first wire rope, in which the jib is installed to be capable of moving up/down and right/left and turning, wherein the first wire rope winds up around the drum when the drum turns in a first direction and unwinds from the drum when the drum turns in a second direction that is the opposite direction to the first direction, a second wire rope having one end fixed to the drum and winding up around the drum when the drum turns in the second direction and unwinding from the drum when the drum turns in the first direction, a supporting boom structure, installed at the body structure substantially symmetrically with the jib, for movably supporting the second wire rope, and a counterweight connected to the other end of the second wire rope.

It is preferred in the present invention that the second wire rope drawn from the drum is extended to the counterweight by using a wire rope extension with a plurality of sheaves, so that the hook can be moved up/down a greater distance than the counterweight.

### BRIEF DESCRIPTION OF THE DRAWINGS

FIG. 1 is a perspective view of a conventional hoisting apparatus;

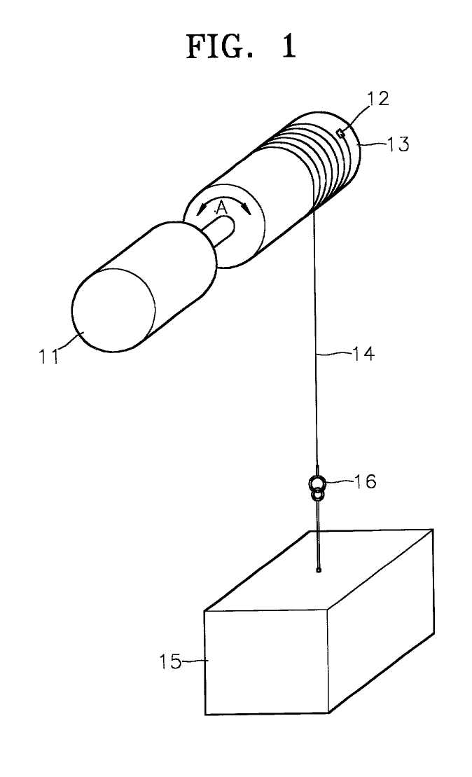

FIG. 2 is a perspective view of a conventional elevator;

FIG. 3 is a perspective view of a hoisting apparatus using a counterweight according to a first preferred embodiment of the present invention;

FIG. 4 is a perspective view of a hoisting apparatus using a counterweight according to a second preferred embodiment of the present invention;

FIG. 5 is a perspective view of a hoisting apparatus using a counterweight according to a third preferred embodiment of the present invention;

FIG. 6 is a perspective view of a hoisting apparatus using a counterweight according to a fourth preferred embodiment of the present invention;

FIG. 7 is a perspective view of a hoisting apparatus using a counterweight according to a fifth preferred embodiment of the present invention;

FIG. 8 is a perspective view of a wire rope towed trolley type crane using a counterweight according to a sixth preferred embodiment of the present invention;

FIG. 9 is a perspective view of a machinery trolley type crane using a counterweight according to a seventh preferred embodiment of the present invention;

FIG. 10 is a perspective view showing the detailed arrangement of wire ropes of the trolley and the hook shown in FIG. 9;

FIG. 11 is a perspective view of a machinery trolley type crane using a counterweight according to an eighth preferred embodiment of the present invention; and,

FIG. 12 is a perspective view of a jib crane using a counterweight according to a ninth preferred embodiment of the present invention.

### BEST MODE FOR CARRYING OUT THE INVENTION

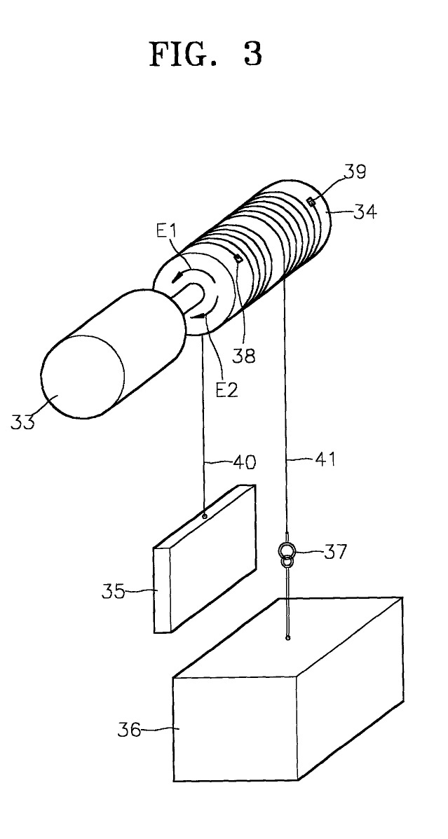

Hereinafter, the present invention will be explained in detail with reference to the attached drawings. FIG. 3 illustrates a hoisting apparatus using a counterweight according to a first preferred embodiment of the invention. In FIG. 3, the hoisting apparatus according to a first preferred embodiment comprises a rotating drum 34 powered by a drive unit 33 which is installed at a certain height in a predetermined structure (not shown), a first wire rope 40 having one end thereof fixed to one side of the rotating drum 34 by several fixing members 38, winding up around the drum 34 when the drum 34 turns clockwise E2, and unwinding from the drum 34 when the drum 34 turns to counterclockwise E1, a second wire rope 41 having one end thereof fixed to the other side of the rotating drum 34 by several fixing members 39, winding up around the drum 34 when the drum 34 turns counterclockwise E1, unwinding from the drum 34 when the drum 34 turns clockwise E2, and having a hook device 37 for hooking and unhooking an object 36 to be hoisted provided at the other end of the second wire rope 41, and counterweight 35 having a predetermined weight and connected to the other end of the first wire rope 40.

The first preferred embodiment of the present invention, the hoisting apparatus using a counterweight as mentioned above, can lift the object 36 up/down by the rotation of the drum 34 which is powered by the drive unit 33 such as an electric motor, as the first wire rope 40 and the second wire rope 41 wind up around or unwind from the drum 34.

For example, when the drum 34 turns counterclockwise E1, the first wire rope 40 unwinds from the drum 34 while the second wire rope 41 winds up around the drum 34, thus the object 36 is lifted up. On the contrary, when the drum 34 turns clockwise E2, the first wire rope 40 winds up around the drum 34 while the second wire rope 41 unwinds from the drum 34, thus lowering the object 36. Therefore, the object 36 can be lifted up or down according to the direction of turning of the drum 34.

Also, in FIG. 3, the first wire rope 40 connected to the counterweight 35 and the second wire rope 41 connected to the object 36 wind around the drum 34 from opposite direction, so that the weight of the object 36 is compensated for by the weight of the counterweight 35. Therefore, the hoisting apparatus with counterweight can lift up a heavier object with the same existing drive unit and requires a drive unit smaller than that of a hoisting apparatus without counterweight.

For example, in FIG. 3, assuming that the weight of the object 36 is 40 tons and that the object 36 is lifted only by the drive unit 33 without the counterweight 35, the drive unit 33 alone must lift up the weight of 40 tons. But when using the counterweight 35 of 40 tons, the weights of the object 36 and the counterweight 35 are the same. Therefore, the hoisting apparatus with counterweight can easily lift up the object 36 as if it lifts up a weightless object.

If the weight of the object 36 is 60 tons and the object 36 is lifted only by the drive unit 33 without the counterweight 35, the drive unit 33 alone must lift up the weight of 60 tons. But when using the counterweight 35 of 40 tons, the drive unit 33 only needs to lift up 20 tons. Therefore, the hoisting apparatus with counterweight can lift up a heavier object with the same drive unit.

Furthermore, in the present invention, there is no need to increase the length of the drum 34 because, when one wire rope winds up around the drum 34, the other wire rope unwinds from the drum 34 simultaneously.

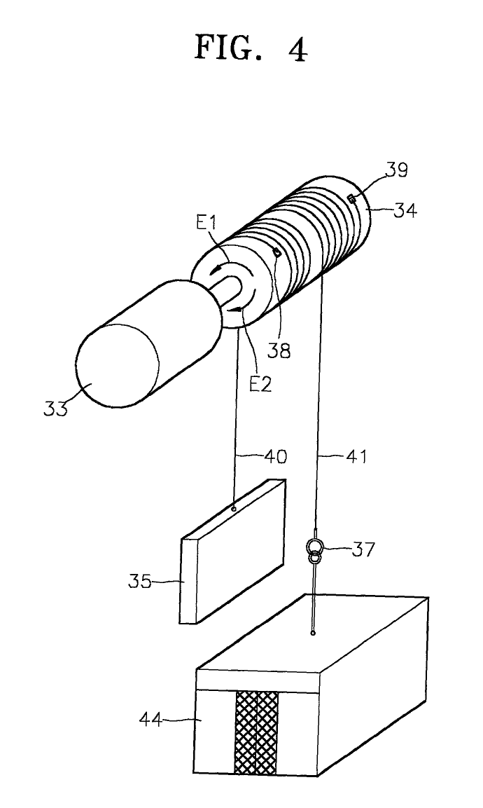

FIG. 4 illustrates a hoisting apparatus using a counterweight according to a second preferred embodiment of the present invention. Although the structure of the hoisting apparatus shown in FIG. 4 is similar to that of FIG. 3, in FIG. 4, the object 36 of FIG. 3 is replaced by an elevator car 44 and the hook device 37 is connected to the elevator car 44.

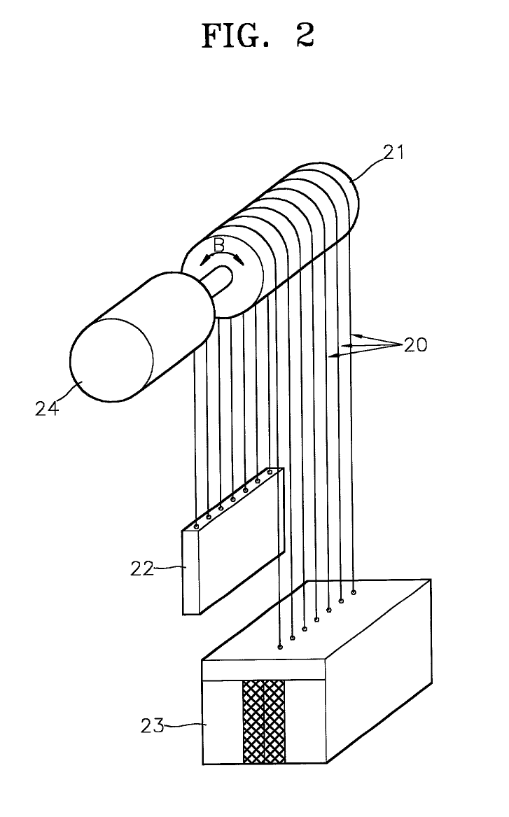

Referring back to the conventional elevator shown in FIG. 2, the wire ropes 20 are connected to the counterweight 22 and the elevator car 23 directly. However, in FIG. 4, one wire rope 40 is connected to the counterweight 35 and the drum 34 while the other wire rope 41 is connected to the elevator car 44 and the drum 34. Therefore, the elevator car 44 can be easily lifted up/down with fewer wire ropes than the hoisting apparatus of FIG. 2.

It is a characteristic feature of the present invention that, even when a difference in weight between the elevator car 44 and the counterweight 35 is big, the elevator car 44 with a brake system only on the drum 34 can move very safely because the wire rope does not slip.

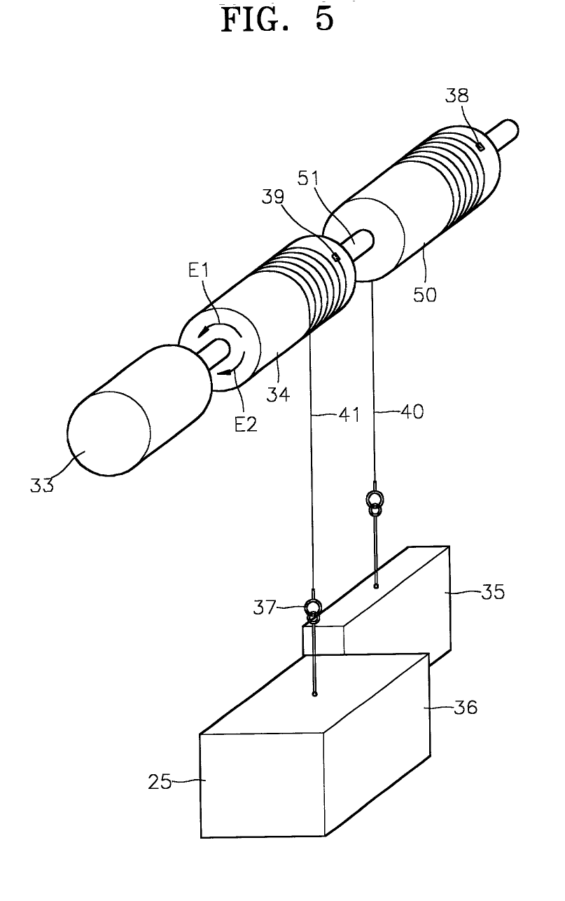

FIG. 5 illustrates a hoisting apparatus using a counterweight according to a third preferred embodiment of the present invention. Referring to FIG. 5, a drum 50 for counterweight is additionally provided to the hoisting apparatus using a counterweight according to the first preferred embodiment of the invention shown in FIG. 3. That is, the counterweight drum 50 is connected to the existing drum 34 by installing a separate turning shaft 51 and the first wire rope 40 is fixed to the counterweight drum 50 by means of fixing members 38. When the counterweight drum 50 turns clockwise E2, the first wire rope 40 winds up around the counterweight drum 50. When the counterweight drum 50 turns counterclockwise E1, the first wire rope 40 unwinds from the counterweight drum 50.

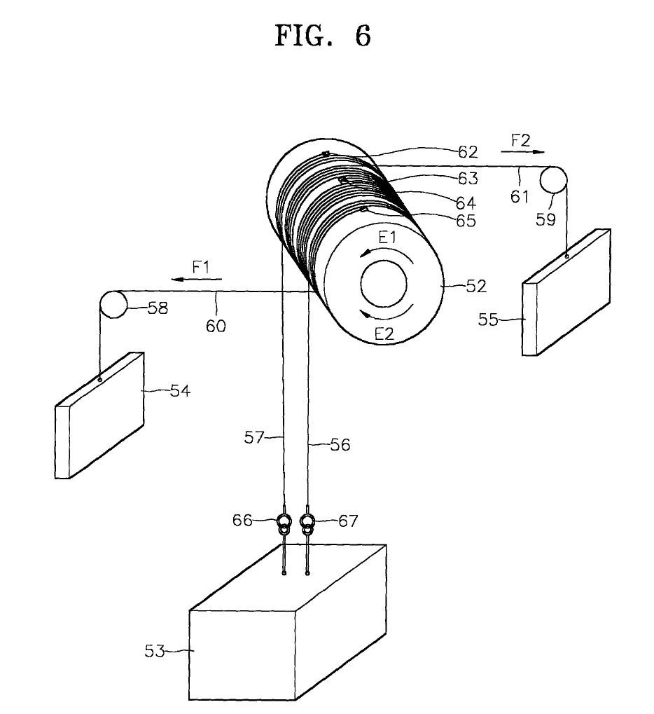

FIG. 6 illustrates a hoisting apparatus using a counterweight according to a fourth preferred embodiment of the present invention. In FIG. 6, the hoisting apparatus of the fourth preferred embodiment comprises a rotating drum 52 powered by a drive unit (not shown) which is installed at a certain height in a predetermined structure (not shown), first and second wire ropes 60 and 61 fixed to the rotating drum 52 at one end by several fixing members 63 and 64, respectively, winding up around the drum 52 when the drum 52 turns counterclockwise E1, and unwinding from the drum 52 when the drum 52 turns clockwise E2, third and fourth wire ropes 57 and 56 fixed to the rotating drum 52 at one end by several fixing members 62 and 65, winding up around the drum 52 when the drum 52 turns clockwise E2, unwinding from the drum 52 when the drum 52 turns counterclockwise E1, and having hook devices 66 and 67 provided at the other end of each of the third and fourth wire ropes 57 and 56 for hooking and unhooking an object 53 to be hoisted, and a first counterweight 54 connected to the other end of the first wire rope 60 and a second counterweight 55 connected to the other end of the second wire rope 61.

Then, the other end of the first wire rope 60 is drawn in a horizontal direction F1 and connected to the first counterweight 54 through a first sheave 58. The other end of the second wire rope 61 is drawn in the opposite direction F2 and connected to the second counterweight 55 through a second sheave 59. Since the first wire rope 60 and the second wire rope 61 are drawn in opposite direction, a load is not applied to the drum 52 in the horizontal direction, with the help of the first and the second wire ropes 60 and 61. Thus, in the hoisting apparatus using a counterweight according to the fourth preferred embodiment of the present invention, a body having the drum 52 can move horizontally without any interruption.

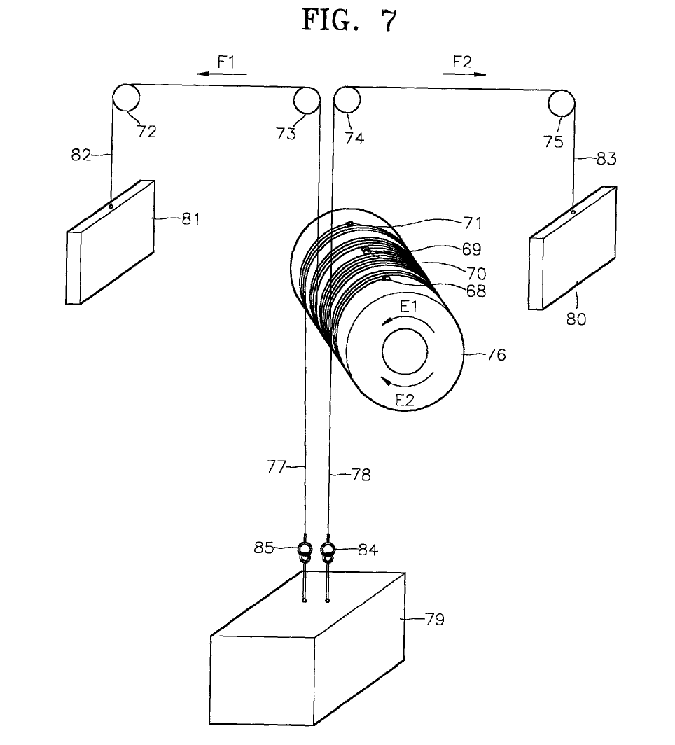

FIG. 7 illustrates a hoisting apparatus using a counterweight according to a fifth preferred embodiment of the present invention. In FIG. 7, the hoisting apparatus of the fifth preferred embodiment comprises a rotating drum 76 which is installed in a predetermined structure (not shown) at a certain height and powered by a drive unit (not shown), first and second wire ropes 82 and 83 fixed to the rotating drum 76 at one end by several fixing members 69 and 70, respectively, winding up around the drum 76 when the drum 76 turns counterclockwise E1, and unwinding from the drum 76 when the drum 76 turns clockwise E2, third and fourth wire ropes 78 and 77 fixed to the rotating drum 76 at one end by several fixing members 68 and 71, winding up around the drum 76 when the drum 76 turns clockwise E2, unwinding from the drum 76 when the drum 76 turns counterclockwise E1, and having hook devices 84 and 85 for hooking and unhooking an object 79 to be hoisted, provided at the other end of each of the third and fourth wire ropes 78 and 77, and a first counterweight 81 connected to the other end of the first wire rope 82 and a second counterweight 80 connected to the other end of the second wire rope 83.

Then, the end of the first wire rope 82 is drawn in a vertical direction, then drawn in a horizontal direction F1 by a first sheave 73, and connected to the first counterweight 81 through a second sheave 72. The other end of the second wire rope 83 is drawn in a vertical direction, then drawn in the opposite direction F2 through a third sheave 74, and connected to the second counterweight 80 through a fourth sheave 75.

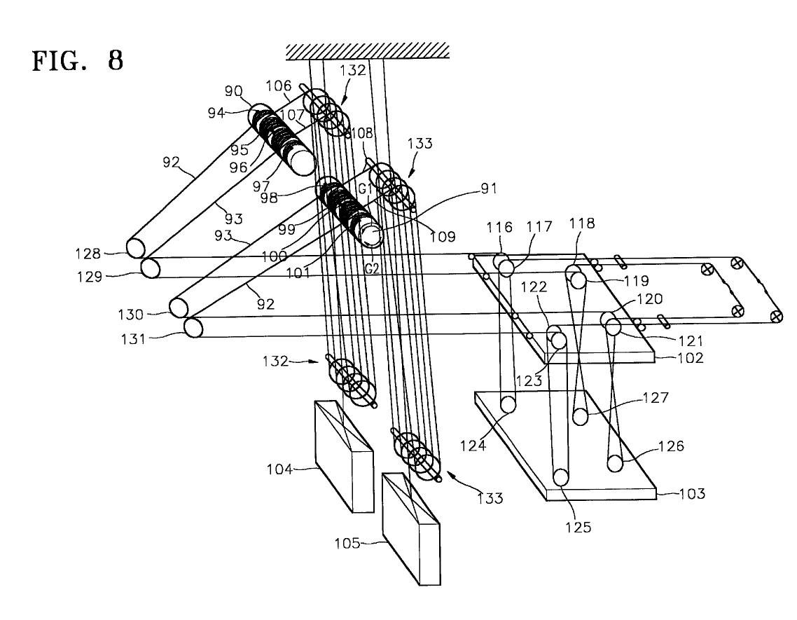

FIG. 8 illustrates a wire rope towed trolley type crane using a counterweight according to a sixth preferred embodiment of the present invention. Here, a wire rope towed trolley type crane which is one of the existing hoisting apparatuses adopts a hoisting apparatus using a counterweight according to the present invention. First, the structure of a conventional wire rope towed trolley type crane will be described.

As shown in FIG. 8, the conventional wire rope towed trolley type crane comprises a trolley 102 which is installed in a predetermined structure (not shown) capable of moving horizontally along the predetermined structure in order to relocate a hoisted object (not shown), a hook device (not shown) for hooking and unhooking the object to be hoisted, a hook 103 which is connected to the trolley 102 by a plurality of sheaves 116 through 131, a first wire rope 92, and a second wire rope 93 for moving up/down, and first and second drums 90 and 91 installed at a certain height to be capable of rotating by a power unit (not shown).

The first wire rope 92 is fixed to the first drum 90 by fixing members 94 and the other end thereof is fixed to the second drum 91 by fixing members 101. The second wire rope 93 is fixed to the first drum 90 by fixing members 97 and the other end thereof is fixed to the second drum 91 by fixing members 98. When the first drum 90 and the second drum 91 turn clockwise G2, the first wire rope 92 and the second wire rope 93 wind up around the first drum 90 and the second drum 91, respectively. When the first drum 90 and the second drum 91 turn counterclockwise G1, the first wire rope 92 and the second wire rope 93 unwind from the first drum 90 and the second drum 91, respectively.

As described above, in the conventional wire rope towed trolley type crane, the rotation of the drums 90 and 91 powered by the drive unit acts on the wire ropes 92 and 93 to wind them around or unwind them from the drums 90 and 91 for lifting up/down the hook 103 and the object which is hooked up to the hook 103.

However, the hoisting apparatus used in the conventional wire rope towed trolley type crane is powered only by the drive unit such as an electric motor. So, the heavier an object to be hoisted is, the more powerful the drive unit must be or the greater reducing ratio a gear reducer should have. It is a weak point that electric consumption is high because weight lifting is done only by the electric motor.

To solve this problem, the wire rope towed trolley crane using a counterweight according to the sixth preferred embodiment of the present invention, in addition to the structure of the conventional wire rope towed trolley type crane, comprises a third wire rope 106 and a fourth wire rope 107 both fixed to the first drum 90 at one end by fixing members 95 and 96, respectively. When the first drum 90 turns counterclockwise G1, the third and fourth wire ropes 106 and 107 wind up around the first drum 90. When the first drum 90 turns clockwise G2, the third and fourth wire ropes 106 and 107 unwind from the first drum 90.

A fifth wire rope 108 and a sixth wire rope 109 are fixed to the second drum 91 at one end by fixing members 99 and 100, respectively. When the second drum 91 turns counterclockwise G1, the fifth and sixth wire ropes 108 and 109 wind up around the second drum 91. When the second drum 91 turns clockwise G2, the fifth and sixth wire ropes 108 and 109 unwind from the second drum 91.

A first counterweight 104 is connected to other ends of the third and fourth wire ropes 106 and 107. A second counterweight 105 is connected to other ends of the fifth and sixth wire ropes 108 and 109.

The third wire rope 106 and the fourth wire rope 107 which are drawn from the first drum 90 are extended to the first counterweight 104 by using of a first wire rope extension 132 with a plurality of sheaves. The fifth wire rope 108 and the sixth wire rope 109 are drawn from the second drum 91 are extended to the second counterweight 105 by using of a second wire rope extension 133 with a plurality of sheaves. The first and second wire rope extensions 132 and 133 enable the first and second counterweights 104 and 105 to move up/down a shorter distance than the vertical distance moved by the hook 103.

In the wire rope towed trolley type crane using a counterweight according to the sixth preferred embodiment of the present invention, when a drive unit (not shown) turns the first drum 90 and the second drum 91 clockwise G2, the first wire rope 92 and the second wire rope 93 wind up around the first drum 90 and the second drum 91, respectively. Then, the third wire rope 106 and the sixth wire rope 109 unwind from the first drum 90 and the second drum 91, respectively. Then, the first counterweight 104 and the second counterweight 105 descend and the hook 103 ascends, so the object connected to the hook 103 also ascends.

When the drive unit turns the first drum 90 and the second drum 91 counterclockwise G1, the first wire rope 92 and the second wire rope 93 unwind from the first drum 90 and the second drum 91, respectively. Then, the third wire rope 106 and the sixth wire rope 109 wind up around the first drum 90 and the second drum 91, respectively. Then, the first counterweight 104 and the second counterweight 105 ascend and the hook 103 descends, so the object connected to the hook 103 also descends.

Therefore, when adequate counterweight is used, the weight of an object is compensated for by the counterweight. So, a heavier object can be lifted with the same existing drive unit, or a relatively smaller drive unit can be used for the same weight lifting.

Practically, referring to a container gantry crane, the hook 103 is needed to move down to the bottom of a container ship. However, the first counterweight 104 and the second counterweight 105 can be moved down to the ground floor only. Therefore, in this preferred embodiment of the present invention, by extending the third wire rope 106 and the sixth wire rope 109 with the help of the first wire rope extension 132 and second wire rope extension 133, the hook 103 can move up/down a greater distance than the first counterweight 104 and the second counterweight 105.

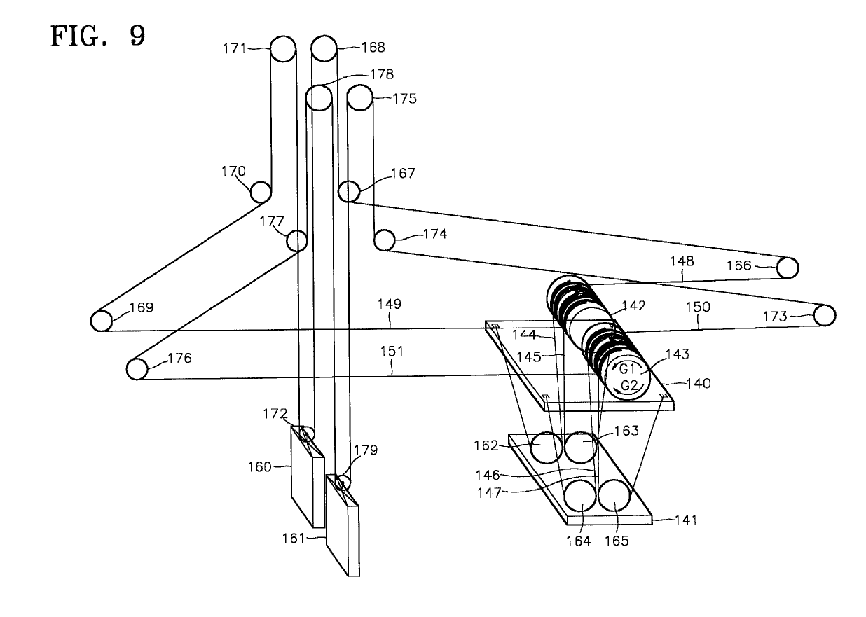

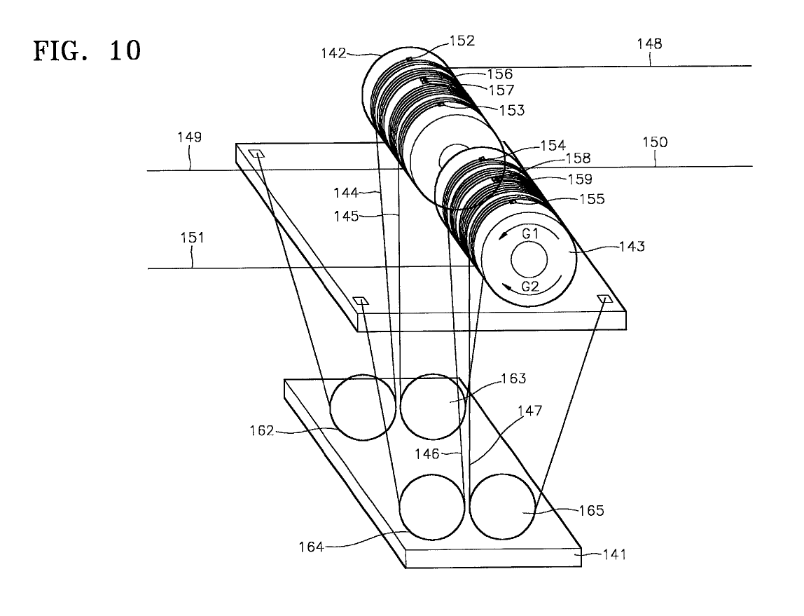

FIG. 9 illustrates a machinery trolley type crane using a counterweight according to a seventh preferred embodiment of the present invention. FIG. 10 shows in detail the arrangement of wire ropes of the trolley and the hook shown in FIG. 9.

First, the structure of a conventional machinery trolley type crane will be described. As shown in FIG. 9, the conventional machinery trolley type crane comprises a trolley 140 installed in a predetermined structure (not shown) capable of moving horizontally along the predetermined structure in order to relocate a hoisted object (not shown) and having a drive unit (not shown), a first drum 142 and a second drum 143 capable of rotating, and a first wire rope through fourth wire rope 144-147 fixed to the first drum 142 and the second drum 143 at one end by fixing members 152 and 155 and connected to a fixed portion at the other end, respectively, and a hook 141 having a predetermined hook device (not shown) for hooking and unhooking the object to be hoisted which is connected to the trolley 140 by four sheaves 162 through 165, capable of moving up/down by the first wire rope through the fourth wire rope 144-147.

In the conventional machinery trolley type crane, when the first drum 142 and the second drum 143 turn clockwise G2, the first wire rope through the fourth wire rope 144-147 wind up around the first drum 90 and the second drum 91, respectively. When the first drum 142 and the second drum 143 turn counterclockwise G1, the first wire rope through the fourth wire rope 144-147 unwind from the first drum 142 and the second drum 143, respectively. As the hook 141 is lifted up/down, the object connected to the hook 141 is moved up/down accordingly.

However, a hoisting apparatus used in the conventional machinery trolley type crane is powered only by a drive unit such as an electric motor. So, the heavier an object to be hoisted is, the more powerful the drive unit must be or the greater the reducing ratio of a gear reducer should be.

To solve this problem, the machinery trolley type crane using a counterweight according to the seventh preferred embodiment of the present invention shown in FIGS. 9 and 10, in addition to the conventional machinery trolley type crane, comprises fifth through eighth wire ropes 148-151, a plurality of sheaves 166 through 179, and first and second counterweights 160 and 161.

The fifth wire rope 148 and the sixth wire rope 149 are fixed to the first drum 142 at one end by fixing members 156 and 157, respectively. When the first drum 142 turns clockwise G2, the first wire rope 144 and second wire rope 145 wind up around the first drum 142 while the fifth wire rope 148 and the sixth wire rope 149 unwind from the first drum 142. When the first drum 142 turns counterclockwise G1, the first wire rope 144 and second wire rope 145 unwind from the first drum 142 while the fifth wire rope 148 and the sixth wire rope 149 wind up around the first drum 142.

The seventh wire rope 150 and the eighth wire rope 151 are fixed to the second drum 143 at one end by fixing members 158 and 159, respectively. When the second drum 143 turns clockwise G2, the third wire rope 146 and the fourth wire rope 147 wind up around the second drum 143 while the seventh wire rope 150 and the eighth wire rope 151 unwind from the second drum 143. When the second drum 143 turns counterclockwise G1, the third wire rope 146 and fourth wire rope 147 unwind from the second drum 143 while the seventh wire rope 150 and the eighth wire rope 151 wind up around the second drum 143.

The other ends of the fifth wire rope 148 and the sixth wire rope 149 are connected to the first counterweight 160 through the sheaves 166, 167, 168, 169, 170, and 171 and the first counterweight sheave 172. The other ends of the seventh wire rope 150 and the eighth wire rope 151 are connected to the second counterweight 161 through the sheaves 173, 174, 175, 176, 177, and 178 and the second counterweight sheave 179.

As shown in FIGS. 9 and 10, in the machinery trolley type crane using a counterweight according to the seventh preferred embodiment of the present invention, the fifth wire rope 148 and the sixth wire rope 149 are drawn in the opposite direction. Because the trolley 140 usually moves horizontally on a track (not shown), if the fifth wire rope 148 and the sixth wire rope 149 are drawn in the same direction, the trolley 140 cannot stay in its position.

Hence, the fifth wire rope 148 and the sixth wire rope 149 drawn in opposite direction from the first drum 142 are connected to each other, forming a single wire rope, through the sheaves 166, 167, 168, 169, 170, and 171, as shown in FIG. 9. Also, for the same reason, the seventh wire rope 150 and the eighth wire rope 151 drawn in opposite direction from the second drum 143 are connected to each other, forming a single wire rope, through the sheaves 173, 174, 175, 176, 177, and 178, as shown in FIG. 9.

In this preferred embodiment, it is shown the fifth wire rope 148 and the sixth wire rope 149 form a single wire rope and that the seventh wire rope 150 and the eighth wire rope 151 form a single wire rope. However, there is no need for the fifth wire rope 148 and the sixth wire rope 149 to be a single wire rope and for the seventh wire rope 150 and the eighth wire rope 151 to be a single wire rope, as long as another separate wire rope is connected to the counterweight.

The explanation of the operation of the machinery trolley type crane will be omitted due to its similarity to that of the wire rope towed trolley type crane.

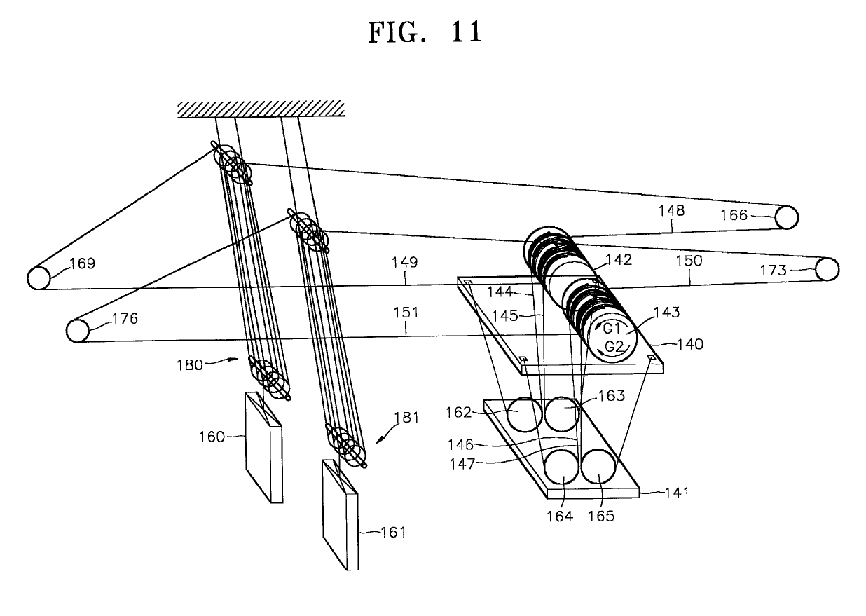

FIG. 11 shows a machinery trolley type crane using a counterweight according to an eighth preferred embodiment of the present invention. The machinery trolley type crane is similar to the machinery trolley type crane using a counterweight shown in FIG. 9, except for the following points. The fifth wire rope through the eighth wire rope 148-151 are extended by means of the first wire rope extension 180 and the second wire rope extension 181. Thus, the hook 141 can move up/down a greater distance than the first counterweight 160 and the second counterweight 161.

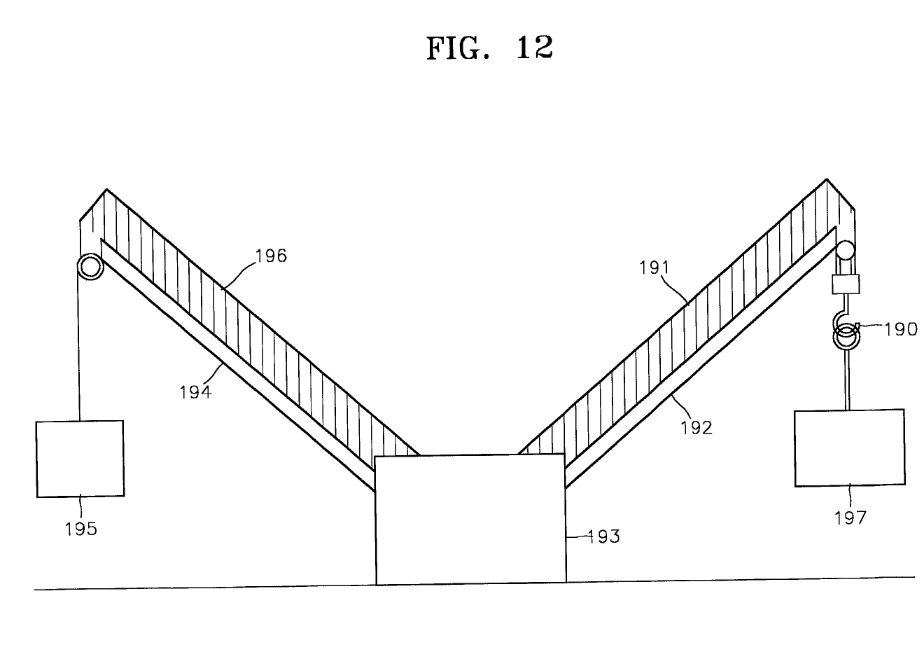

FIG. 12 shows a jib crane using a counterweight according to a ninth preferred embodiment of the present invention. Referring to FIG. 12, the jib crane using a counterweight comprises a jib 191 equipped with a hook device 190, a drive unit (not shown), a turning drum (not shown), a first wire rope 192, and a predetermined structural body 193, for moving an object 197 up/down and left/right. The first wire rope 192 winds up around the drum when the drum turns clockwise in the first direction. The first wire rope 192 unwinds from the drum when the drum turns counterclockwise in the second direction.

The jib crane using a counterweight according to the ninth preferred embodiment of the present invention further comprises a second wire rope 194 fixed to the drum at one end and winding up around the drum when the drum turns counterclockwise and unwinding from the drum when the drum turns clockwise, a supporting boom 196, installed at the structural body 193 to be substantially symmetrical with the jib 191, for supporting the second wire rope 194 capable of moving, and a counterweight 195 having a predetermined weight and connected to the other end of the second wire rope 194.

It is preferred in the present invention that, in the jib crane using a counterweight according to the ninth preferred embodiment of the present invention, the second wire rope 194 drawn from the drum is extended to the counterweight 195 by using the wire rope extension (not shown) of the second wire rope 195 with a plurality of sheaves (not shown). Therefore, the hook 190 can move up/down a greater distance than the counterweight 195.

The jib crane using a counterweight according to the ninth preferred embodiment of the present invention can hoist the object 197 easily while the second wire rope 194 unwinds from the drum and the counterweight 195 descends and the first wire rope 192 winds up around the drum.

The hoisting apparatus using a counterweight based on the present invention can use a smaller drive unit on the counterweight drum and wire rope, or lift a heavier object easily using the same drive unit as existing hoisting apparatuses.

### INDUSTRIAL APPLICABILITY

The hoisting apparatus using a counterweight technology according to the present invention can be applied to all kinds of cranes and elevators and is not limited to the preferred embodiments described above.

This application claims priority from the Korean Patent Application No. 10-2001-0046034, the contents of which are hereby incorporated by reference in their entirety, including the specification, drawings and claims.

What is claimed is:

1. A hoisting apparatus using a counterweight comprising:
a drum which turns when driven by electric power and is installed at a predetermined height in a predetermined structure;
a first wire rope having one end fixed to the drum, winding up around the drum when the drum turns in a first direction and unwinding from the drum when the drum turns in a second direction that is opposite to the first direction;
a second wire rope having one end fixed to the drum, winding up around the drum when the drum turns in the second direction, unwinding from the drum when the drum turns in the first direction, and having a predetermined hook device for hooking and unhooking an object to be hoisted, installed at the other end of the second wire rope; and
a counterweight connected to the other end of the first wire rope.

2. The apparatus as claimed in claim 1, wherein the object is an elevator car for carrying persons or cargo and the hook device provided at the other end of the second wire rope is connected to the elevator car.

3. The apparatus as claimed in claim 1, wherein a drum for counterweight is connected to an additional rotation shaft installed at the drum and the first wire rope is fixed to the counterweight drum, so that when the counterweight drum turns in the first direction, the first wire rope winds up around the counterweight drum and, when the counterweight drum turns in the second direction, the first wire rope unwinds from the counterweight drum.

4. The apparatus as claimed in claim 1, wherein a third wire rope is further provided, has one end fixed to the drum and winds up around the drum when the drum turns in the first direction, the other end of the first wire rope is drawn in a third direction that is a horizontal direction and is connected to the counterweight through a first sheave, and the other end of the third wire rope is drawn in a fourth direction that is the opposite direction to the third direction and is connected to another counterweight through a second sheave, so that a load in the horizontal direction is not applied to the drum with the help of the first and third wire ropes.

5. The apparatus as claimed in claim 1, wherein a third wire rope is further provided, has one end fixed to the drum and winds up around the drum when the drum turns in the first direction, the other end of the first wire rope is drawn vertically and then drawn in a third direction that is a horizontal direction by a first sheave and is connected to the counterweight through a second sheave, and the other end of the third wire rope is drawn vertically and then in a fourth direction that is the opposite direction to the third direction by a third sheave and is connected to another counterweight through a fourth sheave.

6. A wire rope towed type crane using a counterweight comprising:
a trolley installed at a predetermined structure to be capable of moving horizontally;
a hook having a hook device for hooking and unhooking an object to be hoisted and connected to the trolley to be capable of moving up and down by a plurality of sheaves and first and second wire ropes;
first and second drums installed at a predetermined height to be rotated by a drive unit, wherein one end of each of the first and second wire ropes is fixed to the first drum and the other ends thereof are fixed to the second drum, so that, when the first and second drums turn in a first direction, the first and second wire ropes wind up around the first and second drums, respectively, and when the first and second drums turn in a second direction that is the opposite direction to the first direction, the first and second wire ropes unwind from the first and second drums, respectively;
a third wire rope having one end thereof fixed to the first drum and winding up around the first drum when the first drum turns in the second direction and unwinding from the first drum when the first drum turns in the first direction;
a fourth wire rope having one end thereof fixed to the second drum and winding up around the second drum when the second drum turns in the second direction and unwinding from the second drum when the second drum turns in the first direction;
a first counterweight connected to the other end of the third wire rope; and
a second counterweight connected to the other end of the fourth wire rope.

7. The wire rope towed type crane using a counterweight claimed in claim 6, wherein the third wire rope drawn from the first drum is extended to the first counterweight by using a first wire rope extension with a plurality of sheaves, and the fourth wire rope drawn from the second drum is extended to the second counterweight by using a second wire rope extension with a plurality of sheaves, so that the hook can be moved up/down a greater distance than the first and second counterweights.

8. A machinery trolley type crane using a counterweight comprising:
a trolley installed in a predetermined structure to be capable of moving horizontally and having a drive unit, a rotating drum, and at least one wire rope having one end connected to the drum and the other end fixed to a fixed portion;
a hook having a hook device for hooking and unhooking an object to be hoisted and connected to the trolley so that the hook can move up and down by the wire rope, wherein the wire rope winds up around the drum when the drum turns in a first direction and unwinds from the drum when the drum turns in a second direction that is the opposite direction to the first direction;
a first wire rope having one end fixed to the drum and winding up around the drum when the drum turns in the second direction and unwinding from the drum when the drum turns in the first direction;
a second wire rope having one end fixed to the drum and winding up around the drum when the drum turns in the second direction and unwinding from the drum when the drum turns in the first direction; and
a counterweight connected to the other end of the first wire rope, wherein the other end of the first wire rope is drawn in a third direction that is a horizontal direction and is connected to the counterweight through a plurality of sheaves, and the other end of the second wire rope is drawn in a fourth direction that is the opposite direction to the third direction and is connected to the counterweight through a plurality of sheaves.

9. The machinery trolley type crane using a counterweight as claimed in claim 8, wherein the first wire rope drawn from the drum is extended to the counterweight by using a wire rope extension with a plurality of sheaves, and the second wire rope drawn from the drum is extended to the counterweight by using another wire rope extension with a plurality of sheaves, so that the hook can be moved up/down a greater distance than the counterweight.

10. A jib crane using a counterweight comprising:
a jib having a hook device for hooking and unhooking an object to be hoisted; and
a body structure having a drive unit, a rotating drum, and a first wire rope, in which the jib is installed to be capable of moving up/down and right/left and turning, wherein the first wire rope winds up around the drum when the drum turns in a first direction and unwinds from the drum when the drum turns in a second direction that is the opposite direction to the first direction;
a second wire rope having one end fixed to the drum and winding up around the drum when the drum turns in the second direction and unwinding from the drum when the drum turns in the first direction;
a supporting boom structure, installed at the body structure substantially symmetrically with the jib, for movably supporting the second wire rope; and
a counterweight connected to the other end of the second wire rope.

11. The jib crane using a counterweight as claimed in claim 10, wherein the second wire rope drawn from the drum is extended to the counterweight by using a wire rope extension with a plurality of sheaves, so that the hook can be moved up/down a greater distance than the counterweight.
